(19) United States
(12) Patent Application Publication
(10) Pub. No.: US 2016/0352186 A1
(43) Pub. Date: Dec. 1, 2016

(54) ELECTRIC MACHINE

(71) Applicant: Magna Powertrain GmbH & Co KG, Lannach (AT)

(72) Inventors: Florian Faistauer, Steyr (AT); Thomas Gumpoldsberger, Haidershofen (AT)

(21) Appl. No.: 15/115,129

(22) PCT Filed: Jan. 21, 2015
(86) PCT No.: PCT/EP2015/051150

§ 371 Date: Jul. 28, 2016

(30) Foreign Application Priority Data
Feb. 5, 2014 (DE) 10 2014 202 056.5

(51) Int. Cl. H02K 9/20; H02K 7/00

(52) U.S. Cl. CPC H02K 9/20; H02K 7/003

(57) ABSTRACT

An electric machine is described, having a stator and a rotor, the rotor comprising a rotor shaft which is configured as a hollow shaft, a closed cavity being formed in the hollow shaft, in which closed cavity a vacuum prevails, and in which closed cavity a heat-transporting medium is received, and the hollow shaft having an evaporating region (hot zone) and a condensing region (cold zone), and a steam channel being provided in the cavity, and the surface of the cavity having structures which bring about transport of the condensate of the heat-transporting medium as a result of the rotation.

### CROSS-REFERENCE TO RELATED APPLICATIONS

This application is a U.S. National Stage of International Application No. PCT/EP2015/051150, filed Jan. 21, 2015 and which claims priority to German Application No. DE 10 2014 202 056.5 filed Feb. 5, 2014. The entire disclosure of each of the above listed applications is incorporated herein by reference.

### FIELD

The present invention relates to an electric machine, having a stator and a rotor, the rotor comprising a rotor shaft which is configured as a hollow shaft, a closed cavity being formed in the hollow shaft, in which cavity a vacuum prevails and in which cavity a fluid is received, and the hollow shaft having a heat absorption region (hot zone) and a heat dissipation region (cold zone).

### BACKGROUND

Electric machines having a rotor and a stator develop heat during operation, which heat is to be discharged from the inner region. Rotor shafts which are configured as heat conduction tubes are already known for heat discharge and heat transport.

DE 10 2009 051 114 A1 describes, for example, an electric machine having a hollow shaft of the rotor, which hollow shaft is configured as a closed cavity and is filled with a refrigerant. A three-dimensional transport structure which serves to transport the refrigerant is provided in the cavity. Electric machines having a hollow shaft for the transport of heat are known, furthermore, from DE 10 2007 043 656 A1 and GB 1 361 047 A.

The basis is the object of providing an electric machine in an improved form in comparison with the known solutions. In particular, the present invention is based on the object of developing an electric machine in such a way that more homogeneous temperature distribution and improved discharge of heat and transport of heat are achieved.

### SUMMARY

This object is achieved by way of an electric machine having the features of claim 1.

The electric machine according to the invention is developed in such a way that the shaft which supports the rotor is for its part configured to be hollow and as a heat pipe (heat conduction tube). Waste or frictional heat is produced in the case of rotating machine parts, which heat can lead to thermal overloading of the component or of the associated bearing points. Improved thermal transport from the interior of the machine to the surface is achieved by way of the embodiment of the rotor of an electric machine as a heat conduction tube. In summary, improved cooling of the rotor can lead to an increase in the degree of efficiency of the electric machine. In the case of heat conduction tubes for rotating components, the rotation or the centrifugal forces are utilized in a particularly advantageous way, in order to convey the condensate to the hot side (heat dissipation region).

Heat conduction tubes consist of a closed cavity, in which a vacuum prevails and which contains a small quantity of a heat-transporting medium. The said medium is, for example, water. On account of the prevailing vacuum, the water at the hot end in the interior of the heat conduction tube already evaporates at a low temperature level. The steam then flows to the cold end and condenses there. The condensate is conveyed to the hot side again on account of the rotation and/or the centrifugal forces during operation of the rotor which is configured as a heat conduction tube.

The cavity of the rotor shaft is preferably provided on its inner wall with structuring which brings about the transport of the condensed cooling liquid as a result of the rotation.

Here, the said structure comprises, for example, a conically configured inner wall of the rotor shaft or else a design variant, in which the internal diameter of the hollow shaft is of stepped configuration.

### DESCRIPTION OF THE DRAWINGS

Preferred embodiments of the electric machine will be described by way of example in the following text, reference being made illustratively to the appended drawings, in which:

FIG. 1 shows a section through a rotor shaft which is configured as a heat conduction tube,

FIG. 2 shows a section through a rotor element which is configured as a heat conduction disc,

FIG. 3 shows a section through a further exemplary embodiment of a rotor shaft which is configured as a heat conduction tube,

FIG. 4 shows a perspective view of the sectional illustration according to FIG. 3, and

FIG. 5 shows a perspective view of a sectional illustration of a further configuration of a rotor shaft which is configured as a heat conduction tube.

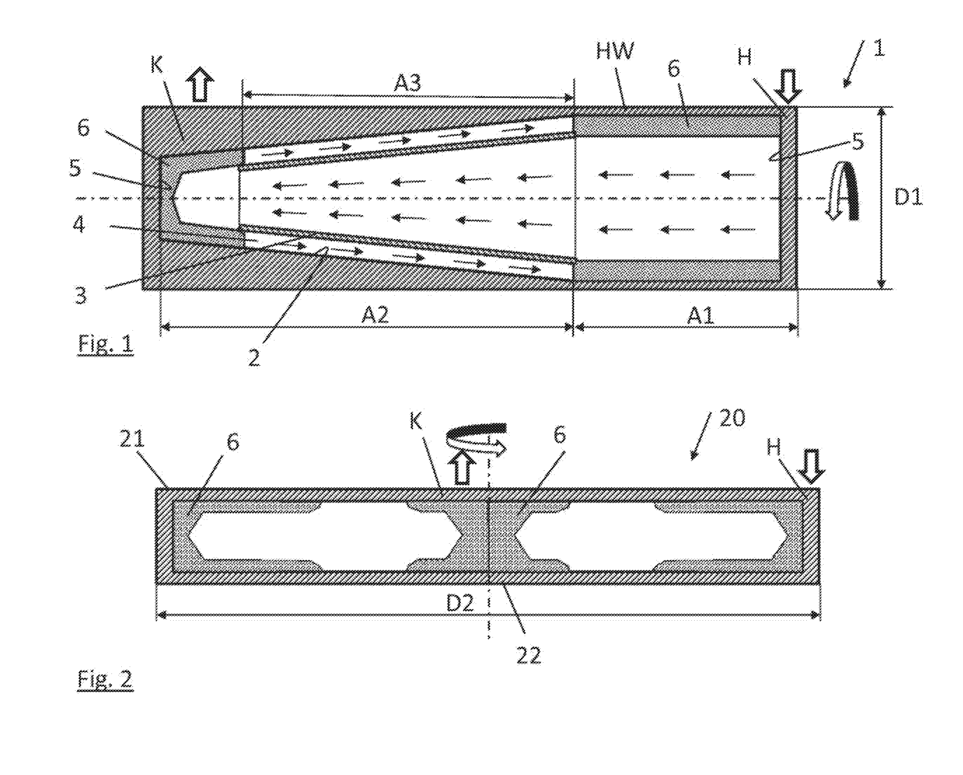

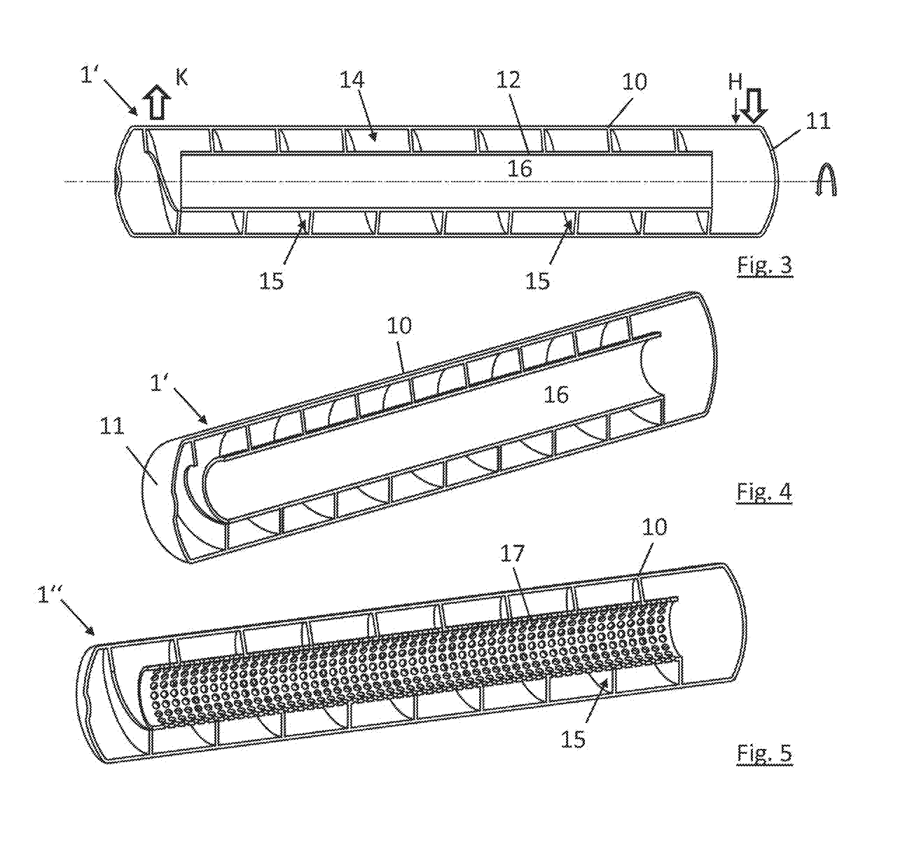

In the following text, rotor shafts which are configured as heat conduction tubes (heat pipes) will be described using FIGS. 1 and 3-5. The rotor shafts can be used in electric machines and are mounted in a manner known per se via bearing points in a housing. A rotor is arranged on the rotor shafts. This fundamental construction is known and is not shown in the drawings.

FIG. 1 shows a first exemplary embodiment of a rotor shaft 1 of an electric machine, which rotor shaft 1 is configured as a heat conduction tube. The rotational axis is illustrated using a dash-dotted line. The rotation is indicated by way of the arrow. The rotor shaft 1 is configured as a closed hollow shaft HW. A heat-transporting medium, for example a fluid such as water, is received in the hollow shaft. A vacuum prevails in the cavity.

The end regions of the rotor shaft define an evaporating region (hot side H) and a condensing region (the cold side K). The evaporating region H is arranged on the right-hand side of the drawing at the end region of the hollow shaft. In the evaporating region, the cavity of the rotor shaft has the greatest diameter D1 and is of cylindrical configuration over a first section A1. The said first cylindrical section A1 is adjoined by a second conical section A2. It can be seen from the sectional illustration that the conically running bore 2 is configured so as to taper towards the end region of the rotor shaft which defines the condensing region. A conical tube 3 is inserted along a section A3 in the section A2. The conical tube 3 is arranged concentrically with respect to the cone which is made in the shaft, and ends in section A2 at a spacing from the end region of the said cone. An additional condensing channel 4 is formed in the cavity of the rotor shaft 1 by way of the arrangement of an additional tube 3. The said condensing channel prevents impeding of the condensate flow by way of the steam flow.

Starting from the end regions of the conical tube 3 as far in each case as an inner end face 5 of the condensing region or the evaporating region, a metal mesh or a metal foam 6 is inserted on the inner circumferential face. This serves at the said locations to increase the surface area and therefore to improve the heat transfer.

In one exemplary embodiment which is not shown, the internal diameter of the hollow shaft can also be configured so as to run, starting from the hot side, in a stepped manner with a smaller diameter to the cold side.

As has already been explained, the evaporating region is arranged at the point of the greatest internal diameter. During operation of the hollow shaft as a rotor/rotor shaft in an electric machine, the heat-transporting medium in the cavity flows as condensate on account of the centrifugal forces to the point of the greatest diameter. Heat is then added at the said point (arrow at H) and evaporates the condensate. Since condensate is resupplied by way of the configuration and arrangement of the conical section, the steam in the region of the hot side is driven away and flows via the steam channel to the points of the heat conduction tube with the smallest diameter, namely the condensing region. The steam channel is situated in the interior of the conical tube 3. The heat is then removed at the condensing region (arrow at K), as a result of which the steam condenses. The condensate then flows via the condensing channel 4 which is configured as a gap between the inner conical circumferential face and the outer circumferential face of the conical tube 3 along the section A3 back in the direction of the condensing region. The heat transport or the circulation of the heat-transporting medium is indicated by way of the arrows.

FIGS. 4 and 5 show a further embodiment of a heat conduction tube 1′. The drawings show a cylindrical hollow shaft 10 which is of closed configuration on the end side via cover elements 11. A tubular element 12 is arranged concentrically in the interior of the hollow shaft. The tubular element 12 is arranged in each case spaced apart from the cover elements 11. In each case, as has already been described with respect to FIG. 1, a metal foam or a woven metal fabric is arranged in the end regions, that is to say the hot region and the cold region. This is not illustrated in the drawings. As can be seen from the sectional illustrations, an Archimedean screw 15 is arranged in the condensing channel which is configured as an annular channel 14 between the tubular element 12 and the inner wall of the hollow shaft 10. Said screw serves to transport condensate from the cold side to the hot side. In summary, the embodiment which is shown can be used only for slowly rotating shafts. The Archimedean screw for returning the condensate from the cold side to the hot side functions only as long as gravity is greater than the centrifugal forces. The steam channel 16 is delimited by way of the inner cavity of the tubular element 12.

In a modification from the embodiment which is shown in FIGS. 4 and 5, FIG. 5 shows a heat conduction tube, in which the tubular element 17 is designed in a perforated embodiment.

FIG. 2 shows a sectional illustration of a rotor disc 20. The latter is configured as a flat, hollow disc-shaped element (hollow disc) and is likewise of closed or sealed configuration. The heat conduction disc 20 is also filled with a small quantity of a heat-transporting medium and has been set at a vacuum. The hot zone H is situated in the outer edge region on the outer circumference 21 of the rotor disc with the maximum disc diameter D2. The cold zone or the heat dissipation region/condensing region is arranged in the region of the rotational axis 22 of the rotor disc 20. As can be seen from the sectional illustration, metal meshes or metal foams M for increasing the surface area are arranged in the region of the inner wall of the disc-shaped element both in the region of the hot zone H and L in the region of the cold zone. This serves for improved heat distribution and uniform distribution of the condensate.

As has already been described with respect to the rotating heat conduction tubes according to FIGS. 1 and 3-5, the condensate is hurled outwards to the hot zone by way of centrifugal force. There, the condensate is evaporated by way of the introduction of heat via the hot zone, and the steam is displaced in the direction of the cold zone by the following condensate. In the cold zone, the steam condenses with heat discharge to the metal mesh or the metal foam in the said region and discharge to the outside via the cold zone. As has already been described with respect to the other embodiments, additional plates can also be arranged in the rotor disc, which plates form a condensing channel and delimit the condensate flow and the steam flow.

The above-described rotor disc 20 generally serves for heat transport in the radial direction in the case of rotating components. Optional uses are, for example, rotor blades, brake discs, clutch discs, electric motors, turbine rotors and compressor rotors.

In one design variant which is not shown, combinations of rotor discs 20 and heat conduction tubes are also possible. Here, the heat can be conducted in a radial direction first of all via a rotor disc to a heat conduction tube, and subsequently the heat can be transported and dissipated via the hot zone of a heat conduction tube in the axial direction to the cold zone/heat dissipation region.

1. An electric machine, comprising a stator and a rotor, the rotor comprising a rotor shaft configured as a hollow shaft, a closed cavity formed in the hollow shaft, in which closed cavity a vacuum prevails, and in which closed cavity a heat-transporting medium is received, and the hollow shaft having an evaporating region (hot zone H) and a condensing region (cold zone K), and a steam channel being provided in the cavity, and the surface of the cavity having structures which bring about transport of the condensate of the heat-transporting medium as a result of rotation of the rotor shaft.

2. The electric machine according to claim 1, wherein the evaporating region and the condensing region are configured at opposite end regions of the hollow shaft.

3. The electric machine according to claim 1, wherein the structure is configured as a conically running bore, starting from a diameter D1 which is configured in the evaporating region so as to taper towards the condensing region.

4. The electric machine according to claim 1, wherein the structure is configured as a bore of stepped configuration with cylindrical bore sections, and wherein the cylindrical bore section having the greatest diameter is configured in the evaporating region.

5. The electric machine according to claim 1, wherein a condensing channel is provided in the cavity of the rotor shaft between the evaporating region and the condensing region, and wherein the condensing channel conducts the condensate from the condensing region to the evaporating region.

6. The electric machine according to claim 5, wherein the condensing channel is formed by way of a tube which is arranged concentrically and spaced apart from an inner circumferential face of the rotor shaft.

7. The electric machine according to claim 1, wherein a metal mesh and/or a metal foam is arranged in the cavity of the rotor shaft in at least one of the evaporating region and in the condensing region.

8. The electric machine according to claim 1, wherein an Archimedean screw for transporting the condensate is arranged along the condensing channel.

9. The electric machine according to claim 1, wherein the rotor comprises a rotor disc which is configured as a hollow disc, a closed cavity being formed in the hollow disc, in which closed cavity a vacuum prevails, and in which closed cavity a heat-transporting medium is received, and wherein the hollow disc having an evaporating region (hot zone) which lies on the outer circumference of the rotor disc and a condensing region (cold zone) which lies in the region of the rotor axis, and a steam channel being provided in the cavity.
